(19) United States
(12) Patent Application Publication
(10) Pub. No.: US 2025/0321856 A1
(43) Pub. Date: Oct. 16, 2025

(54) PRE-TRAINED LARGE LANGUAGE MODEL DRIVEN BUG LOCALIZATION

(71) Applicant: Oracle International Corporation, Redwood Shores, CA (US)

(72) Inventors: Mahinthan CHANDRAMOHAN, Brisbane (AU); Dai NGUYEN, Brisbane (AU); Padmanabhan KRISHNAN, Brisbane (AU)

(73) Assignee: Oracle International Corporation, Redwood Shores, CA (US)

(21) Appl. No.: 18/659,216

(22) Filed: May 9, 2024

Related U.S. Application Data
(60) Provisional application No. 63/633,639, filed on Apr. 12, 2024.

(51) Int. Cl. G06F 11/36; G06F 40/40

(52) U.S. Cl. CPC G06F 11/3608; G06F 40/40

(57) ABSTRACT

A method implements pre-trained large language model driven bug localization. The method includes receiving a report and applying a fine-tuned language model to report text from the report, to source text from a source file of a set of source files, and to commit text from a commit of a set of commits to respectively generate a report vector, a source vector, and a commit vector from the fine-tuned language model. The method further includes applying a similarity model to the report vector and the source vector to generate a report source score and includes applying the similarity model to the report vector and the commit vector to generate a report commit score. The method further includes applying a ranking model to the report source score and the report commit score to identify the source file corresponding to the report and includes presenting the source file responsive to the report.

### CROSS REFERENCE TO RELATED APPLICATIONS

This application claims benefit under 35 U.S.C. § 119 (e) to U.S. Patent Application Ser. No. 63/633,639 filed on Apr. 23, 2024. U.S. Patent Application Ser. No. 63/633,639 is incorporated herein by reference.

### BACKGROUND

A bug in software development is an aberration in the code that leads to unexpected behavior or malfunctions within software systems. Bugs can manifest in various forms, from minor glitches to catastrophic failures, undermining the reliability and functionality of the program. Bugs may be elusive and challenging to detect, posing significant challenges to developers to rectify for the time and computer resources used to investigate, debug, and test. Bugs may be reported as errors that arise from factors such as logic flaws, syntax errors, unexpected interactions between different components of the codebase, etc.

Software bugs are common in software development. After a bug is identified in a report, the location of the bug may be identified in one or more source files that may be revised to address the report and fix the bug. However, identifying the relevant source files for revision in a project with many source files is time-consuming and error prone when there are multiple files and when the reports may not contain sufficient information. The location where the bug manifests is not necessarily where the actual bug is located.

### SUMMARY

A method implements pre-trained large language model driven bug localization. The method includes receiving a report. The method further includes applying a fine-tuned language model to report text from the report, to source text from a source file of a set of source files, and to commit text from a commit of a set of commits to respectively generate a report vector, a source vector, and a commit vector from the fine-tuned language model. The method further includes applying a similarity model to the report vector and the source vector to generate a report source score. The method further includes applying the similarity model to the report vector and the commit vector to generate a report commit score. The method further includes applying a ranking model to the report source score and the report commit score to identify the source file corresponding to the report. The method further includes presenting the source file responsive to the report.

A system implements pre-trained large language model driven bug localization. The system includes at least one processor and an application that executes on the at least one processor. Executing the application performs receiving a report and applying a fine-tuned language model to report text from the report, to source text from a source file of a set of source files, and to commit text from a commit of a set of commits to respectively generate a report vector, a source vector, and a commit vector from the fine-tuned language model. Executing the application further performs applying a similarity model to the report vector and the source vector to generate a report source score. Executing the application further performs applying the similarity model to the report vector and the commit vector to generate a report commit score. Executing the application further performs applying a ranking model to the report source score and the report commit score to identify the source file corresponding to the report. Executing the application further performs presenting the source file responsive to the report.

A non-transitory computer readable medium includes instructions executable by at least one processor to implement pre-trained large language model driven bug localization. Executing the instructions performs receiving a report. Executing the instructions further performs applying a fine-tuned language model to report text from the report, to source text from a source file of a set of source files, and to commit text from a commit of a set of commits to respectively generate a report vector, a source vector, and a commit vector from the fine-tuned language model. Executing the instructions further performs applying a similarity model to the report vector and the source vector to generate a report source score. Executing the instructions further performs applying the similarity model to the report vector and the commit vector to generate a report commit score. Executing the instructions further performs applying a ranking model to the report source score and the report commit score to identify the source file corresponding to the report. Executing the instructions further performs presenting the source file responsive to the report.

Other aspects of one or more embodiments may be apparent from the following description and the appended claims.

### BRIEF DESCRIPTION OF DRAWINGS

FIG. 1, FIG. 2, and FIG. 3 show diagrams in accordance with one or more embodiments of the disclosure.

FIG. 4A and FIG. 4B show flowcharts in accordance with one or more embodiments of the disclosure.

FIG. 5, FIG. 6, FIG. 7, FIG. 8, FIG. 9, FIG. 10, and FIG. 11 show examples in accordance with one or more embodiments of the disclosure.

FIG. 12A and FIG. 12B show computing systems in accordance with one or more embodiments.

Similar elements in the various figures are denoted by similar names and reference numerals. The features and elements described in one figure may extend to similarly named features and elements in different figures.

### DETAILED DESCRIPTION

Embodiments of the disclosure perform pre-trained large language model driven bug localization. One or more embodiments automatically identify the source files where a bug is originated to reduce the needed time and computer resources spent maintaining the source files in a code repository. Further, in one or more embodiments, cross-application and cross-language use cases are supported in which the source files may be for different applications and use different programming languages.

Bugs may be located by processing the source files of an application with the report of the bug using a fine-tuned large language model. The fine-tuned large language model is generated by updating a pre-trained language model. The updates to the pre-trained language model are generated using several loss functions operating on several vectors and scores generated from training data that includes reports and sources files with bugs that were resolved. The training data may be enhanced by selecting source files (and segments of the source files) that are similar to the files or segments that were updated to resolve the bug but were not edited to resolve the bug. The use of similar files that were not revised to resolve the bug enhances the training of the pre-trained language model to identify and locate segments of code and source files that may contain the logic errors, syntax errors, glitches, etc., that may be resolved to fix the bugs identified in reports.

When using an embodiment of the disclosure, a user may select a set of source files and a report in a request for the system to analyze and locate source files and code segments that may be relevant to the bug identified in the report. The system may extract text from the text of the source files, a commit message of a commit, and the report to generate vectors using the fine-tuned language model. The vectors may be further processed to generate similarity scores between the report, the source files, and the commit messages. The similarity scores are used to rank the files identified in the source files and identified by the commit of the commit message. One or more of the ranked files may then be presented in a response to the user displayed on the computing system operated by the user. In an embodiment, the analysis may be performed automatically upon the submission of a report of a bug to be displayed with the report of the bug to a developer.

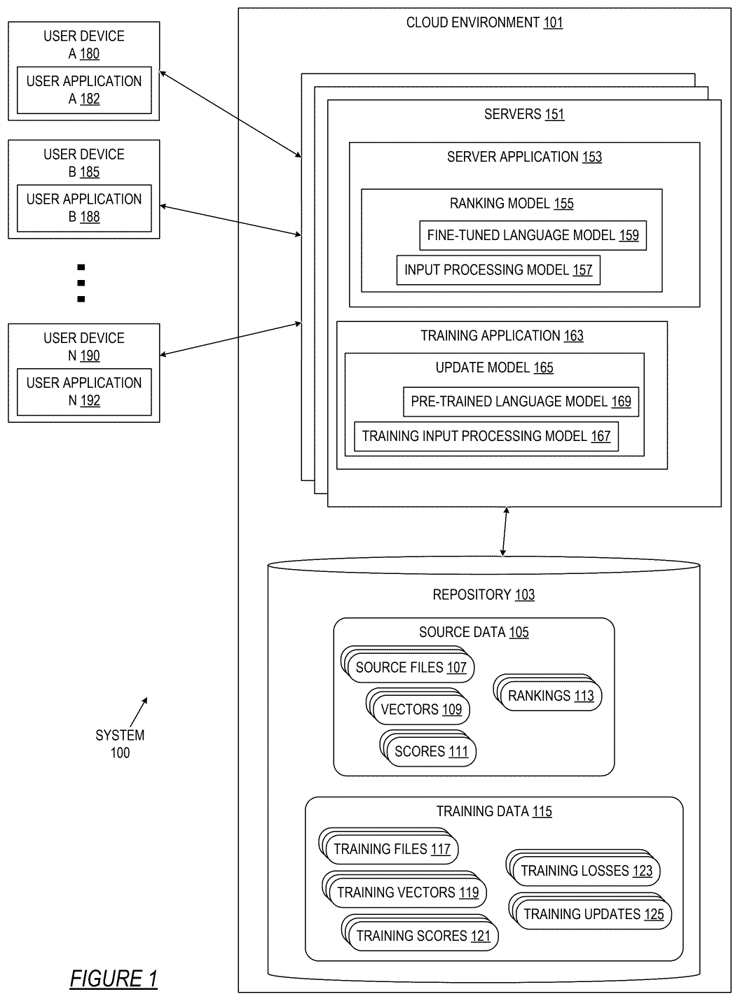

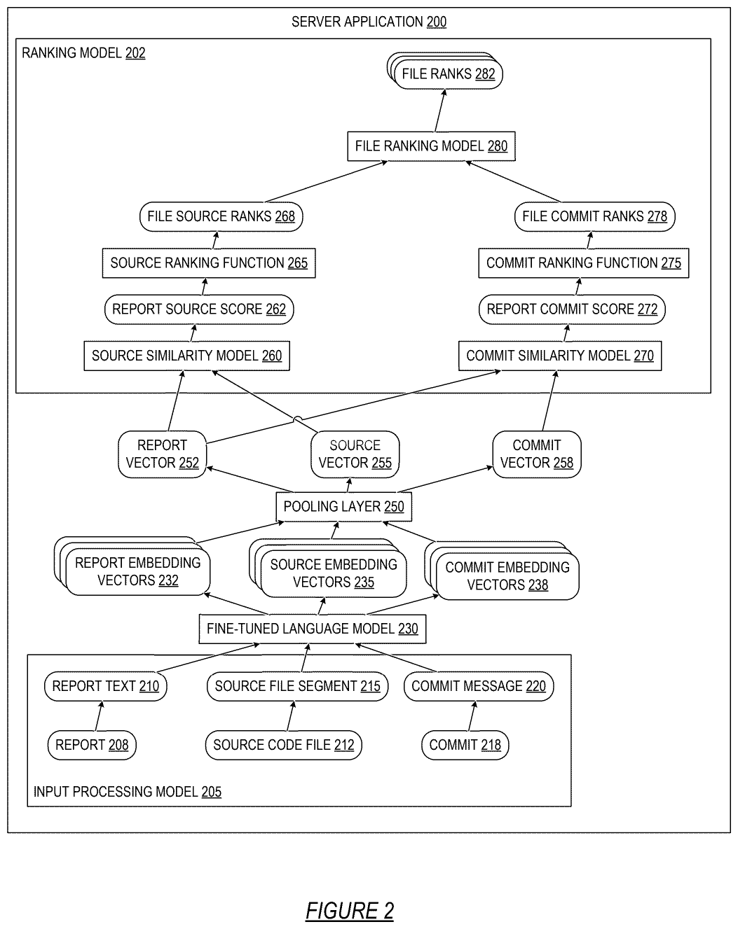

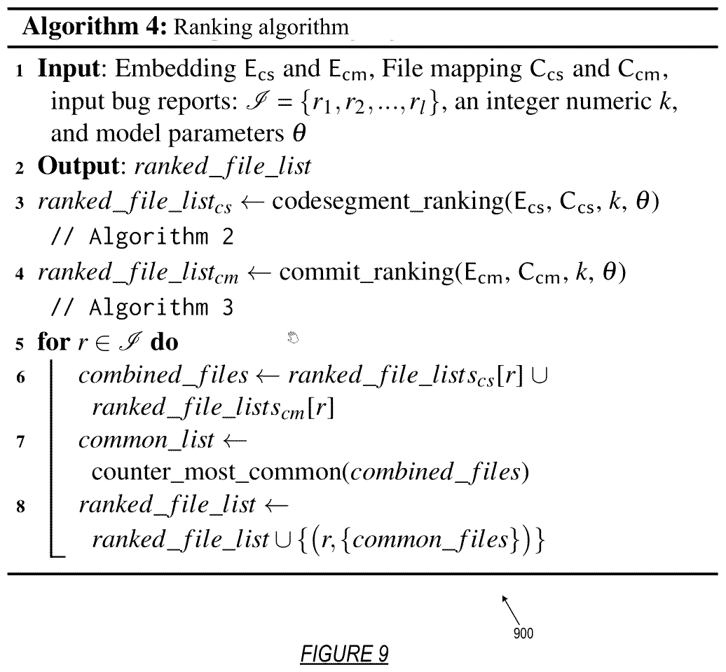

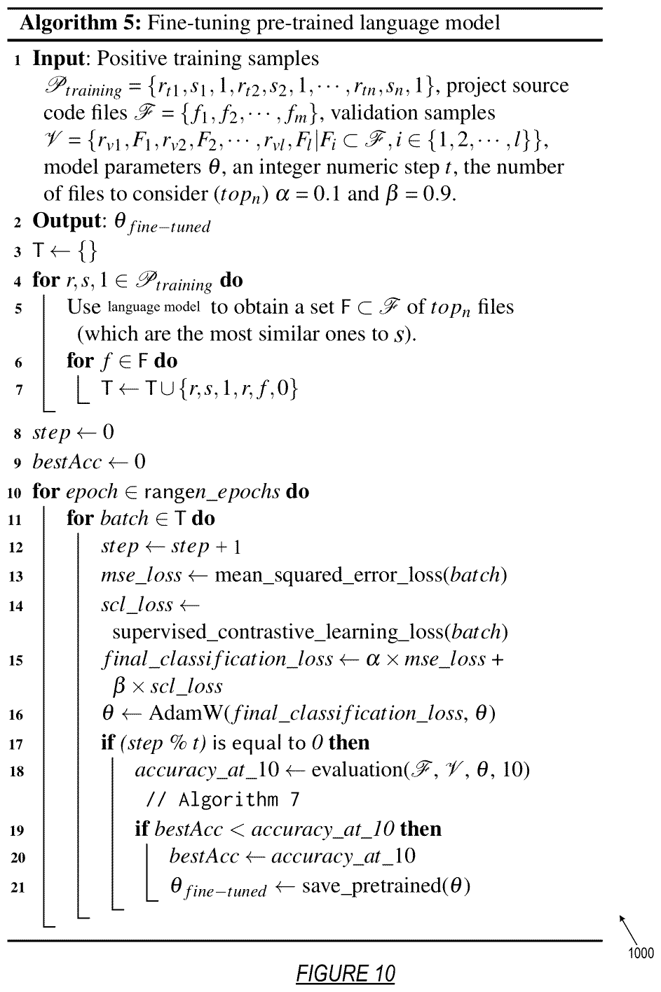

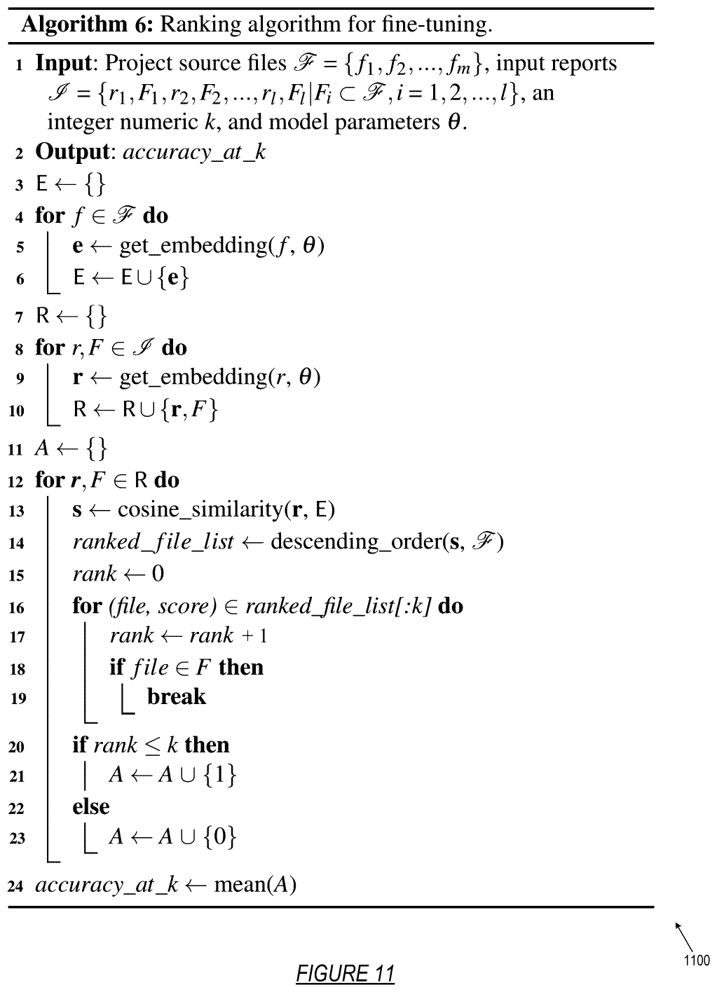

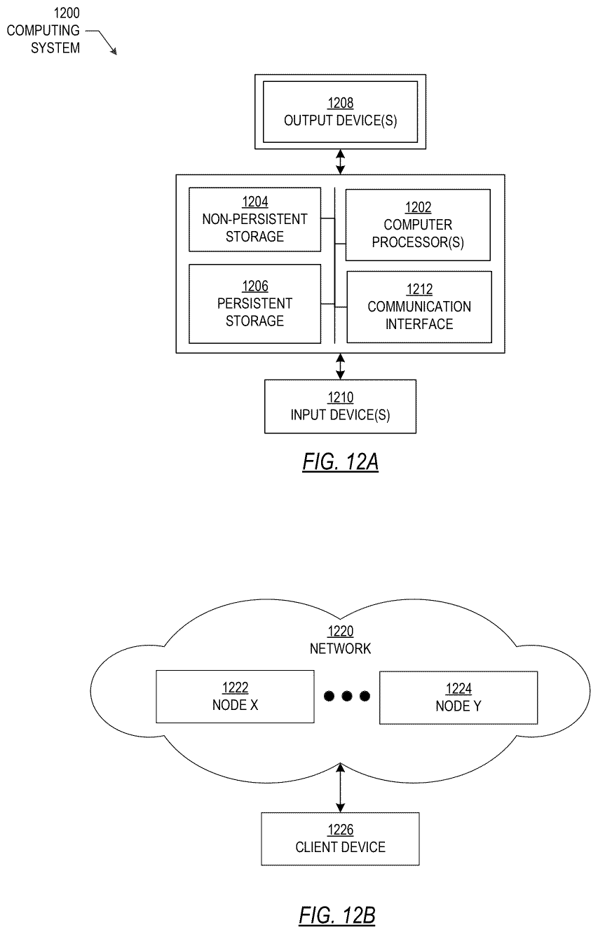

Turning to FIG. 1, the system (100) is a computing system shown in accordance with one or more embodiments. The system (100) and corresponding components may utilize the computing systems described in FIG. 12A and FIG. 12B to perform static dataflow analysis for build pipelines. The system (100) includes the cloud environment (101) with the servers (151) that communicate with the user devices A (180) and B (185) through N (190).

The cloud environment (101) is a server system having one or more servers, whereby the server system may be an on-premises solution or part of a network environment. The cloud environment (101) may be public, private, or hybrid. The resources provided by the cloud environment (101), e.g., the servers (151), may be scaled through dynamic allocation to meet the demand of the users of the system (100). The cloud environment (101) includes the servers (151) and the repository (103).

The repository (103) is a type of storage unit and/or device (e.g., a file system, database, data structure, or any other storage mechanism) for storing the data used by the system (100). The repository (103) may include multiple different, potentially heterogenous, storage units and/or devices. The repository (103) stores data utilized by other components of the system (100). The data stored by the repository (103) includes the source data (105) and the training data (115).

The source data (105) is data that is processed to perform bug localization. The source data (105) includes the source files (107), the vectors (109), the scores (111), the rankings (113), etc.

The source files (107) are collections of data for computer programs and applications. The source files (107) include information that may be stored as text. The source files (107) may include reports, source code files, commits, etc., for a programming project.

A report may be a recorded description of a bug of a system. A report may include text that provides a description of a bug, a set of steps for reproduction of the bug, environment information, severity level, etc., that may be used to diagnose, analyze, and resolve the bug. The reports in the source files (107) may be identified as “open” to indicate that a bug described with a report has not been resolved and may still be present when an application is executed.

A source code file may be files with source code. The source code may be a set of instructions written in a programming language to define the behavior and functionality of a software application. Programming languages used to write source code include high-level programming languages such as Python, Java, C++, and JavaScript, and low-level languages like assembly and machine code. Source code may be compiled or interpreted to executable instructions that, when executed, may cause a computing system to perform the tasks or operations defined in the source code.

A commit is a specific snapshot of changes made to one or more files in a repository. A commit may be made with a version control system and serves as a record of modifications to the codebase at a particular point in time. In an embodiment, a commit may include a hash value, author information, a commit message, a changeset, one or more parent commits, etc. In an embodiment, the hash value is a unique identifier for the commit, which may be generated from the contents of the commit using a cryptographic hash function. In an embodiment, the author information may include the name and email address of the person who created the commit to track who made the changes. In an embodiment, a commit message is a brief description of the changes included in the commit written using natural language and stored as text. In an embodiment, a changeset includes the changes made to the files of the repository for the software project, which may include additions, deletions, modifications, etc., to files and directories. In an embodiment, parent commits are references to the previous commits from which the current commit originated, to provide a chronological link and version history. For example, a set of commits may track changes to the source file over time.

The vectors (109) are collections of data that may represent features, attributes, or characteristics, etc., of information processed by the system (100). The vectors (109) may each be organized as a multidimensional array for storage and processing to facilitate mathematical operations such as dot products, matrix multiplications, distance calculations, similarity calculations, etc. The vectors (109) may include embedding vectors, generated from the source files (107), as well as other vectors for intermediate calculations performed when processing the source files (107) to generate the rankings (113). An embedding vector is a numerical representation of a data point in a high-dimensional space, which may be generated word embeddings or feature embeddings algorithms. Embedding vectors may capture semantic or structural relationships between entities for natural language processing, recommendation systems, information retrieval, etc.

The scores (111) are values generated from processing one or more of the source files (107) and the vectors (109), which may be used to generate the rankings (113). In an embodiment, the scores (111) may be scalar values and represent the similarity between other values. For example, the scores (111) may identify the similarity between the vectors (109) to represent the similarity between different source files (107), e.g., between reports, commits, source code files, etc.

The rankings (113) are values generated from processing the source files (107), the vectors (109), and the scores (111). The rankings (113) may rank the source code files of the source files (107) to the reports of the source files (107) to predict the source code files that may be relevant to a report. For example, when a first source code file has a higher rank than a second source code file for a report of a bug, then the first source code file may have a higher probability of containing the bug than the second source code file.

The training data (115) is data used to train the machine learning models of the system (100). For example, the pre-trained language model (169) may be trained (i.e., “fine-tuned”) using the training data (115). The training data (115) includes the training files (117), the training vectors (119), the training scores (121), the training losses (123), and the training updates (125).

The training files (117) are the files used to train the machine learning models. In an embodiment, the training files (117) may include copies of the source files (107). In an embodiment, reports in the training files (117) may be identified as “closed” to indicate that a bug described with a report has been resolved and is no longer present when an application is executed.

The training vectors (119) are multi-dimensional arrays used to train the machine learning models of the system (100). The training vectors (119) may be generated during training from the training files (117) and used to calculate the training losses (123). The training vectors (119) may be different from the vectors (109).

The training scores (121) are values generated from processing one or more of the training files (117) and the training vectors (119). The training scores (121) may be used to generate the training losses (123). The training scores (121) may be different from the scores (111).

The training losses (123) are values generated from processing one or more of the training files (117), the training vectors (119), and the training scores (121). The training losses (123) may be used to generate the training updates (125). In an embodiment, the training losses (123) identify the differences between values predicted by models of the system (100) and values that are expected. For example, a similarity score of “0.4” may predict that two files are not similar when the expected similarity score is “1.0” to indicate that the files are similar. In the example, the training loss may be “0.6” (i.e., 1.0-0.4). The numbers 0.4, 0.6, and 1.0 are for example purposes only.

The training updates (125) are updates generated during training from the training losses (123). The training updates (125) may include updates that may be applied to the pre-trained language model (169) to form the fine-tuned language model (159).

Continuing with FIG. 1, the system (100) also may include the servers (151). The servers (151) are one or more computing systems in the cloud environment (101). The servers (151) may be added or removed from the system (100) on demand based on utilization of the system (100) by the users of the system (100). An example of the servers (151) may be the computing system (1200) shown in FIG. 12A. The servers (151) are the hardware used to operate the server application (153) and the training application (163).

The server application (153) is a collection of programs operating on one or more of the servers (151). In an embodiment, the server application (153) communicates with the user applications A (182) to N (192) to receive requests that may include or identify the source files (107) and transmit responses that may include the rankings (113). The server application (153) may process the source files (107) to generate the vectors (109), the scores (111), and the rankings (113) using the ranking model (155), the input processing model (157), and the fine-tuned language model (159). An embodiment of the server application (153) is discussed in further detail with FIG. 2.

The ranking model (155) is a collection of programs operated by the server application (153). The ranking model (155) is a machine learning model that is trained to generate the rankings (113) from the source files (107). In an embodiment, after the source files (107) are processed with the input processing model (157) and the fine-tuned language model (159), the ranking model (155) may process the vectors (109) and the scores (111) to generate the rankings (113).

The input processing model (157) is a collection of programs that may be part of the ranking model (155). The input processing model (157) processes the source files (107) to extract text and prepare the extracted text for input to the fine-tuned language model (159). For example, the input processing model (157) may process the source files (107) to generate embedding vectors stored in the source vectors (109).

The fine-tuned language model (159) is a collection of programs that operate as a machine learning model. In an embodiment, the fine-tuned language model (159) may be a large language model (LLM). The fine-tuned language model (159) may take text, tokens, or vectors as input and output vectors, tokens, or text. For example, the fine-tuned language model (159) may receive embedding vectors generated by the input processing model (157) that are processed to generate output vectors stored in the vectors (109). The outputs of the fine-tuned language model (159) may be processed by the ranking model (155) to generate vectors, scores, and rankings stored in the vectors (109), the scores (111), and the rankings (113) in the repository (103).

The training application (163) is a collection of programs operating on one or more of the servers (151). In an embodiment, the training application (163) fine-tunes the pre-trained language model (169) by training the pre-trained language model (169) with the training data (115). The training application (163) uses the update model (165) to train the pre-trained language model (169).

The update model (165) is a collection of programs operated by the training application (163). The update model (165) is a machine learning model that updates the pre-trained language model (169) to form the fine-tuned language model (159). The update model (165) processes vectors (109) and scores (111) from the training vectors (119) and the training scores (121) to generate losses in the training losses (123). The update model (165) processes the losses to generate updates in the training updates (125). The update model (165) applies the updates to the pre-trained language model (169) to generate the fine-tuned language model (159). An embodiment of the training application (163) is discussed in further detail with FIG. 3.

The training input processing model (167) is a collection of programs that may be part of the update model (165). The training input processing model (167) processes the training files (117) to extract text and prepare the extracted text for input to the pre-trained language model (169). For example, the training input processing model (167) may process the training files (117) to generate embedding vectors stored in the training vectors (119).

The pre-trained language model (169) is a machine learning model trained on a vast corpus of text data to understand and generate human-like language. The training teaches the pre-trained language model (169) to predict the likelihood of a word or sequence of words given a prompt. The pre-trained language model (169) be used by various applications, including conversational agents, content generation, document summarization, information retrieval, code completion, etc. The pre-trained language model (169) takes the same type of inputs as the fine-tuned language model (159) and provides the same type of outputs.

Continuing with FIG. 1, the user devices A (180) and B (185) through N (190) may interact with the servers (151). The user devices A (180) and B (185) through N (190) may be computing systems in accordance with FIG. 12A and FIG. 12B. The user devices A (180) and B (185) through N (190) may include and execute the user applications A (182) and B (188) through N (192).

The user applications A (182) and B (188) through N (192) are programs that operate on the user devices A (180) and B (185) through N (190) to provide user interaction by collecting user inputs and displaying outputs in response to the user inputs. The user applications A (182) and B (188) through N (192) may include user interfaces with user interface elements to receive inputs and display outputs to users of the system (100).

In an embodiment, the user device A (180) is operated by a user to analyze the source files (107) and display predictions of which ones of the source files (107) may be revised to resolve a bug described in a report. In an embodiment, the rankings (113) may be displayed by the user device A (180) to show an ordered ranking of one or more files or segments of files from the source files (107). In an embodiment, a user may select a report and a set of the source files (107) that are to be analyzed. After the analysis, the user device A (180) may display the one or more of the set of selected source files (107) in the order of the rankings (113).

In an embodiment, the user device N (190) may be operated by a developer of the system (100). The developer may train (or retrain) the pre-trained language model (169) to generate and then deploy the fine-tuned language model (159).

Although described within the context of a client server environment with servers and user devices, aspects of the disclosure may be practiced with a single computing system and application. For example, a monolithic application may operate on a computing system to perform the same functions as one or more of the applications executed by the servers (151) and the user devices A (180) and B (185) through N (190).

Turning to FIG. 2, the server application (200) is an embodiment of the server application (153) of FIG. 1. The server application (200) processes source files (e.g., including the report (208), the source code file (212), and the commit (218)) to generate the file ranks (282). The server application (200) uses the ranking model (202) and the input processing model (205). The server application (200) may receive requests that identify the source files, process the source files to generate the file ranks (282), and send a response based on the file ranks (282).

The input processing model (205) is a program that operates as part of the server application (200). The input processing model (205) processes the source files to prepare the source files for input to the fine-tuned language model (230). The source files processed by the input processing model (205) includes the report (208), the source code file (212), and the commit (218). The report (208) includes text that may be referred to as report text that forms the report text (210). The source code file (212) includes text that may be referred to as source text, which may include the source file segment (215). The commit (218) may include text referred to as commit text, which may include the commit message (220).

The source files may be processed to convert the text from the source files to tokens and the tokens may be processed to convert the tokens to embedding vectors.

Tokenization converts the text from a source file into tokens. A token may be a numerical identifier that identifies a set of one or more characters. A token may represent a word, a portion of a word, an individual character, etc. After the text is tokenized into tokens, the tokens may be processed with an embedding layer to be converted into embedding vectors. The embedding vectors represent the tokens in a semantic space. Embedding vectors with similar values may have a similar meaning in a natural language. In an embodiment, an embedding vector may be a one dimensional array of multiple values.

In an embodiment, the input processing model (205) may also segment the source files for preparation for input to the fine-tuned language model (230). A segment of a file is a portion of a file. Contiguous segments may overlap.

Segmenting the report may include extracting the report text (210) from the report (208). The report text (210) may be extracted as text, tokens, or embedding vectors. In an embodiment, the report text (210) may be a truncated version of the reports (208). For example, the report text (210) may include the first, e.g., 500 characters, words, tokens, vectors, etc., from the report (208). In other words, the report text (210) may be extracted from the report (208) as a truncated version of the report (208).

The input processing model (205) may segment the source code file (212) into multiple segments that include the source file segment (215). The size of the segments may be fixed and may be based on the context window for the fine-tuned langue model (230). For example, if the fine-tuned language model (230) has a context window of five hundred tokens, then the source file segment (215) may also be five hundred tokens. Additionally, multiple segments may be generated from the source code file (212). The different segments may have overlapping portions. The portions that overlap may overlap by a number of characters, words, tokens, embedding vectors, etc. As an example, the overlap may be twenty tokens at the beginning of the segment, 20 tokens the end of the segment, twenty tokens at both the beginning and the end of the segment, etc. Different number of overlap (e.g., ten, twenty, fifty, etc.) may be used.

The input processing model (205) may also segment the commit (218). The commit (218) may include multiple portions of data. One of which may be the commit message (220). The commit message (220) may be extracted from the commit (218) and may also be truncated. In an embodiment, the segment or truncation size for each of the report text (210), the source segment file (215), and the commit message (220) may be the same size. After being generated by the input processing model (205) the embedding vectors generated for the report text (210), the source segment file (215), and the commit message (220) may be input to the fine-tuned language model (230).

The fine-tuned language model (230) is a program that operates within the server application (200). The fine-tuned language model (230) processes the embedding vectors representing the report text (210), the source file segment (215), and the commit message (220) to respectively generate the report embedding vectors (232), the source embedding vectors (235), and the commit embedding vectors (238). The report embedding vectors (232) are generated by the fine-tuned language model (230) from embedding vectors generated from tokens that represent the report text (210). Similarly, the source embedding vectors (235) are generated from embedding vectors generated from tokens that represent the source file segment (215), and the commit embedding vectors (238) are generated from embedding vectors generated from tokens that represent the commit message (220). In an embodiment, the report embedding vectors (232), the source embedding vectors (235), and the commit embedding vectors (238) are generated by being processed through multiple attention layers within the fine-tuned language model (230). After being generated by the attention layers from the fine-tuned language model (230), the report embedding vectors (232), the source embedding vectors (235), and the commit embedding vectors (238) may be input to the pooling layer (250).

The pooling layer (250) is a portion of the ranking model (202) that generates a single vector from multiple vectors. For example, the pooling layer (250) generates the report vector (252) from the report embedding vectors (232). Similarly, the pooling layer (250) generates the source vector (255) from the source embedding vectors (235) and generates the commit vector (258) from the commit embedding vectors (238).

In an embodiment, the pooling layer (250) may use mean pooling to generate the output. For example, the report vector (252) may be the mean of the report embedding vectors (232). Similarly, the source vector (255) may be the mean of the source embedding vectors (235), and the commit vector (258) may be the mean of the commit embedding vectors (238). The outputs of the pooling layer (250) are used as inputs to the source similarity model (260) and the commit similarity model (270).

The ranking model (202) is a program that may be executed as a part of the server application (200). The ranking model (202) processes report vectors (including the report vector (252)), source vectors (including the source vector (255)), and commit vectors (including the commit vector (258)) to generate the file ranks (282). The ranking model (202) includes the source similarity model (260), the source ranking function (265), the commit similarity model (270), the commit ranking function (275), and the file ranking model (280).

The source similarity model (260) is applied to the report vector (252) and the source vector (255) to generate the report source score (262). The report source score (262) may be a scalar value that identifies the similarity between the report vector (252) and the source vector (255). In an embodiment, the source similarity model (260) may use a cosine similarity function to generate the report source score (262). The cosine similarity is the cosine of the angle between two vectors, which in this case are the report vector (252) and the source vector (255). The report source score (262) may be input into the source ranking function (265).

The source ranking function (265) is a program of the ranking model (202). In an embodiment, the source ranking function (265) may rank a specified number of files, for example, the top K files, where K may define the number of files to rank, e.g., “20”. The source ranking function (265) may operate on the segments of multiple files. The source ranking function (265) ranks source files based on the report source scores for those segments from the corresponding source files. For example, the source code file (212) may be ranked based on the report source score (262) for the source file segment (215). The output of the source ranking function (265) is the file source ranks (268). The file source ranks (268) may order the files (e.g., including the source code file (212)) by corresponding report source scores (e.g. the report source score (262) for the source file segment (215)). When a source file includes more than one segment that is processed by the source ranking function (265), the source file may be ranked based on the segment with the highest report source score. The file source ranks (268) are input to the file ranking model (280) along with the file commit ranks (278) generated by the commit ranking function (275) that processes the report commit score (272) from the commit similarity model (270).

The commit similarity model (270) is a portion of the ranking model (202). The commit similarity model (270) may be applied to the report vector (252) and the commit vector (258) to generate the report commit score (272). In an embodiment, the commit similarity model (270) may use the same similarity function as the source similarity model (260), e.g., cosine similarity. The report commit score (272) is a scalar value that is input to the commit ranking function (275).

The commit ranking function (275) receives report commit scores (including the report commit score (272) for the commit message (220)) and ranks files identified in the commits (including the commit (218)) based on the report commit scores for the commits. In an embodiment, the commit ranking function (275) may identify a specified number of source files (identified by the commits) to form the file commit ranks (278). For example, the commit ranking function (275) may identify the top K source files where K may be the same number as for the source ranking function (265). As an example, the commit ranking function (275) may identify the top “20” files identified in a set of commits to form the file commit ranks (278). The file commit ranks (278) are an input to the file ranking model (280).

The file ranking model (280) is a program that may operate as part of the ranking model (202) and the server application (200). The file ranking model (280) receives the file source ranks (268) and the file commit ranks (278) as inputs. The file ranking model (280) is applied to the file source ranks (268) and the file commit ranks (278) to generate the file ranks (282). In an embodiment, the file ranking model (280) may use a majority voting algorithm to determine the ranks for the source code files in a project. The source code files with higher ranks may have a higher likelihood of being relevant to the bug identified in the report (208).

As an example of majority voting, every time a source code file appears in the file source ranks (268) the file may receive a vote. Additionally, when a source code file is identified in the file commit ranks (278), the source code file may receive another vote. The votes for the different source code files from the file source ranks (268) and from the file commit ranks (278) are tallied, i.e., summed, to generate the file ranks for the source code files.

Turning to FIG. 3, the training application (300) is an embodiment of the training application (163) of FIG. 1. The training application (300) is a program that trains the pre-trained language model (312) to form a fine-tuned language model (e.g., the fine-tuned language model (230) of FIG. 2). The training application (300) fine tunes the pre-trained language model (312) by training the pre-trained language model (312) with the training report (308) and the source code file (310). The training application (300) includes the update model (302).

The update model (302) is a program operating as part of the training application (300) to train the pre-trained language model (312). The update model (302) includes the training input processing model (305).

The training input processing model (305) is a program that operates as part of the update model within the training application (300). The training input processing model (305) processes training source files (e.g., including the training report (308) and the training source code file (310)) to be input to the pre-trained language model (312). The training report (308) and the training source code file (310) may be segmented or truncated. The training source code file (310) may be truncated to the number of tokens that fit within the context window of the pre-trained language model (312). As an example, the pre-trained language model (312) may have a context window of 512 tokens. If the training source code file (310) includes 700 tokens, then the first 512 tokens may be used without the remaining 188 tokens as an input to the pre-trained language model (312). The training input processing model (305) may convert text from the training report (308) and the training source code file (310) to tokens and to embedding vectors for input to the pre-trained language model (312). The training input processing model (305) may use the same tokenizer and embedding model as used by the input processing model (205) of FIG. 2.

The pre-trained language model (312) is a program operated within the update model (302) and the training application (300). The pre-trained language model (312) is applied to inputs from the training input processing model (305). For example, the training report (308) and the training source code file (310) may individually be input to the pre-trained language model (312). Inputs to the pre-trained language model (312) may be characters, text, words, tokens, embedding vectors, etc. The pre-trained language model (312) may be applied to the training report (308) to generate the training report embedding vectors (315) and applied to the training source code file (310) to generate the training source embedding vectors (318). In an embodiment, one of the training report embedding vectors (315) may be generated for each token from the training report (308). Similarly, one of the training source embedding vectors (318) may be generated for each of the tokens from the training source code file (310). The training report embedding vectors (315) and the training source embedding vectors (318) are inputs to the pooling layer (330).

The pooling layer (330) is a layer of the update model (302) that processes vectors after the attention layers of the pre-trained language model (312) have generated the training report embedding vectors (315) or the training source embedding vectors (318). The pooling layer (330) is applied to the training report embedding vectors (315) to generate the training report vector (332), and is applied to the training source embedding vectors (318) to generate the training source vector (335). The pooling layer (330) may operate in a similar fashion as the pooling layer (250) of FIG. 2. In an embodiment, the pooling layer (330) may take the mean of a set of vectors to output a single vector. For example, the training report vector (332) may be the mean of the training report embedding vectors (315). The training report vector (332) and the training source vector (335) are used by the similarity model (338) and the combination model (350).

The similarity model (338) is a model within the update model (302) of the training application (300). The similarity model (338) is applied to the training report vector (332) and to the training source vector (335) to generate the training report source score (340). In an embodiment, the similarity model (338) may apply a cosine similarity function to generate the training report source score (340) from the training report vector (332) and the training source vector (335). The training report source score (340) is an input to the batch loss function A (342).

The batch loss function A (342) is a function that is applied to a batch of samples to identify a loss. In an embodiment, the batch loss function A (342) may be referred to as a scalar loss function for operating on batches of scalar values. In particular, the batch loss function A (342) is applied to a batch of training report source scores (including the training report source score (340)) to generate the batch loss A (345) using the training labels (348). The training labels (348) are labels that identify whether training source code files (including the training source code file (310)) are files that were updated in a commit to resolve the bug identified in the training report (308). For a single batch, the training report (308) may be paired with multiple training source code files (including the training source code file (310)). Some of the training source code files (310) are files that were updated to resolve the bug identified in the training report (308), referred to as a positive sample. Some of the training source code files (310) are not files that were updated to resolve the bug identified in the training report (308), which are identified as negative samples. A positive sample may have a corresponding training label (of the training labels (348)) with a value of “1”. A negative sample may have a corresponding training label (of the training labels (348)) with a value of “0”. Different values may be used. For example, “−1” may be used for a negative sample.

In an embodiment, the batch loss function A (342) may be a mean square error loss function in which the batch loss A (345) is the mean squared error of the error from a batch of training report source scores compared to corresponding training labels (348). The error for one sample may be the difference between the training report source score (340) and one of the training labels (348) that corresponds to the training report source score (340) (e.g., “1” for a positive sample and “0” for a negative sample). The batch loss A (345) is one of the inputs to the loss combination function (370) along with the batch loss B (358) generated by the batch loss function B (355) that uses the training combined vector (352) from the combination model (350).

The combination model (350) is a program that operates within the update model (302) as part of the training application (300). The combination model (350) is applied to the training report vector (332) and the training source vector (335) to generate the training combined vector (352). The combination model (350) combines the training report vector (332) with the training source vector (335) to generate the training combined vector (352). In an embodiment, the training source vector (335) may be appended to the training report vector (332). The training report vector (332) is an input to the batch loss function B (355).

The batch loss function B (355) is a function that is applied to a batch of samples to identify a loss. In an embodiment, the batch loss function B (355) may be referred to as a vector loss function for operating on batches of vector values (in contrast to the batch loss function A (342) that operates on scalar values). In particular, the batch loss function B (355) is applied to a batch of training combined vectors (including the training combined vector (352)) to generate the batch loss B (358) using the training labels (348). In an embodiment, the batch loss function B (355) may use a supervised contrastive learning batch loss function to generate the batch loss B (358) from a batch of combined vectors and the training labels (348).

The loss combination function (370) is a function that operates as part of the update model (302). The loss combination function is applied to the batch loss A (345) and the batch loss B (358) to generate the combined loss (372).

In an embodiment, the loss combination function (370) is a weighted combination function that multiplies a weight to each input and sums the corresponding products. For example, a first weight “a” may be multiplied by the batch loss A (345) to generate a first product, and a second weight “B” may be multiplied by the batch loss B (358) to generate a second product. The first and second products may then be summed to generate the combined loss (372).

The loss function (375) is a function that operates as part of the update model (302). The loss function (375) processes the combined loss (372) to generate the training updates (378), which may be applied to the pre-trained language model (312) to form the fine-tuned language model (230) of FIG. 2.

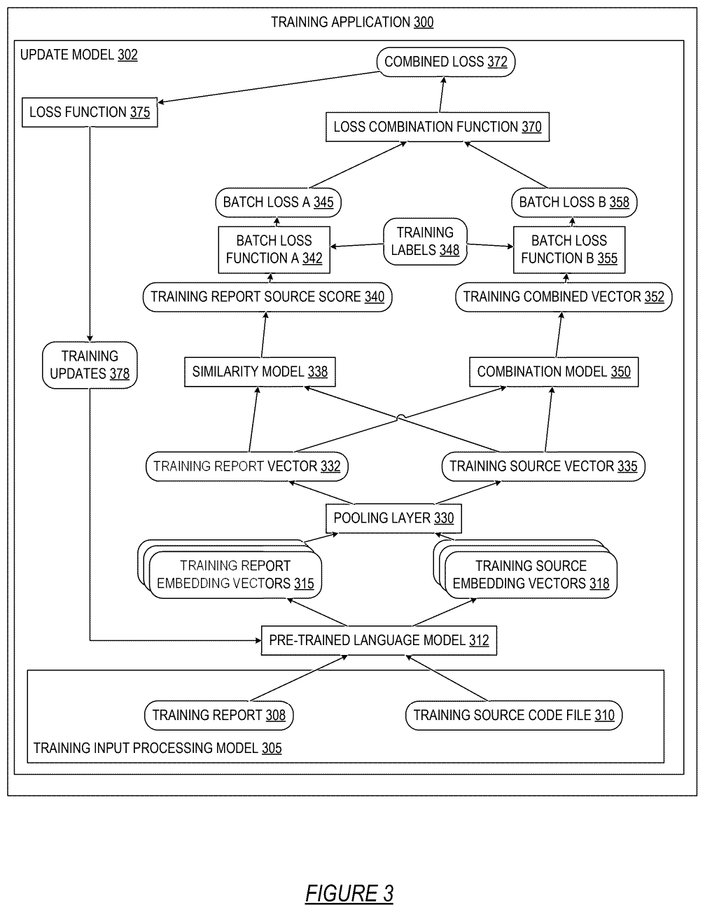

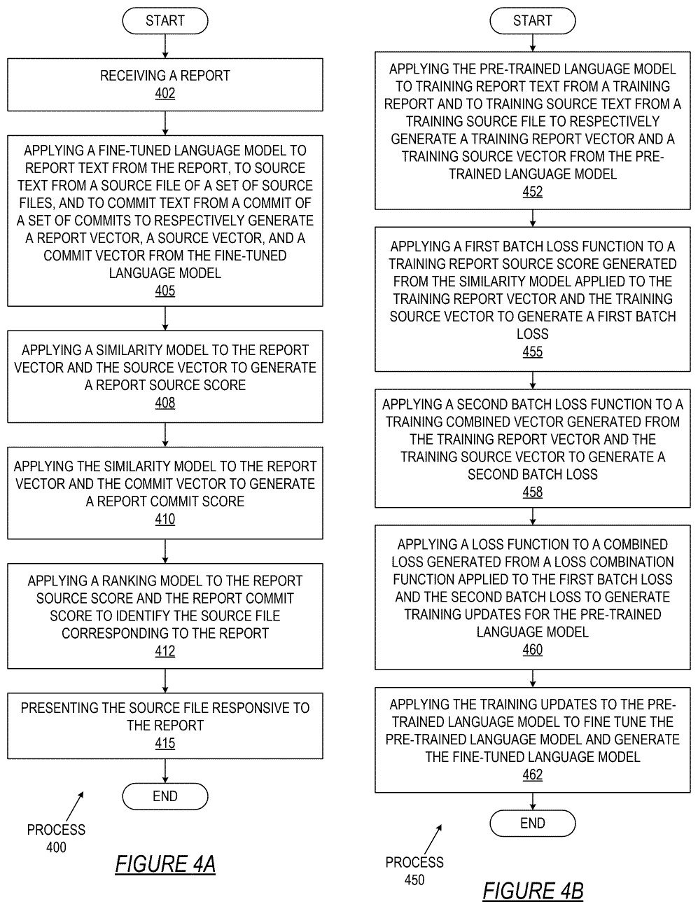

FIG. 4A and FIG. 4B illustrates the process (400) and the process (450), which may be used to implement pre-trained large language model driven bug localization. In an embodiment, a system may include at least one processor and an application that, when executing on the at least one processor, performs one or more of the process (400) and the process (450). In an embodiment, a non-transitory computer readable medium may include instructions that, when executed by one or more processors, perform one or more of the process (400) and the process (450).

Turning to FIG. 4A, the process (400) analyzes source files to generate file ranks using machine learning models. The process (400) may include multiple steps (e.g., steps 402 through 415) that may execute on the components described in the other figures, including those of FIG. 1.

Step 402 includes receiving a report. In an embodiment, the report may be received from a repository that stores reports and source files for a programming project. The report may be referenced in a request in a message from a client device received by a server. The client device may transmit the message to the server using a representational state transfer application program programming interface (REST API). The reference to the report and message may be an identification of the report or may include the contents of the report.

Step 405 includes applying a fine-tuned language model to report text from the report to source text from a source file of a set of source files and to commit text from a commit of a set of commits. Applying the fine-tuned language model respectively generates a report vector, a source vector, and a commit vector from the fine-tuned language model. The fine-tuned language model may be individually applied to the text (i.e., report text, source text, or commit text) by first converting the text to tokens, which are then converted to embedding vectors, which are then input to the fine-tuned language model. The fine-tuned language model processes the embedding vectors (i.e., generated from the reports, source code files, and commits) with multiple machine learning model layers. In an embodiment, the machine learning model layers include attention layers that apply an attention algorithm to the embedding vectors that are input to the fine-tuned language model.

The output of the fine-tuned language model is a set of vectors for the corresponding input. The report vector is one of a set of report vectors generated for the report text extracted from a report. The source vector is one of a set of source vectors generated for a source file segment extracted from a source code file. The commit vector is one of a set of commit vectors generated from a commit message extracted from a commit. The report vector may correspond to report text extracted from a report. The source vector may correspond to the source file segment that is extracted from the text of a source code file. The commit vector may correspond to a commit message extracted from the text of a commit. The set of vectors output from the fine-tuned language model may also be referred to as embedding vectors as the outputs are vectors in the same semantic space (though not the same value) as the vectors input to the fine-tuned language model.

Step 408 includes applying a similarity model to the report vector and the source vector to generate a report source score. In an embodiment, the report source score is a scalar value generated by combining the report vector and the source vector with the similarity model. In an embodiment, the similarity model is a cosine similarity function that generates the report source score. Namely, in the example, the cosine similarity function calculates the cosine similarity between the report vector and the source vector.

The report source score is a scalar value that identifies the similarity between the report vector and the source vector. In an embodiment, the report source score may have a real value between “0” and “1”.

Step 410 includes applying the similarity model to the report vector and the commit vector to generate a report commit score. The report commit score identifies the similarity between the report vector and the commit vector. In an embodiment, the similarity model used to generate the report commit score may be the same as the similarity model used to generate the report source score, and thus, may perform the same calculation albeit with different inputs.

Step 412 includes applying a ranking model to the report source score and the report commit score to identify the source file corresponding to the report. In an embodiment, the source file may be identified with a file rank generated by the ranking model. The ranking model may use several functions to generate the file rank. For example, the ranking model may use a file ranking model that takes inputs from a source ranking function and a commit ranking function. The source ranking function ranks source files based on report source scores that correspond to the source files. The commit ranking function ranks files using report commit scores. The file ranking model may then use a majority voting algorithm to further rank the source files of a programming project based on the outputs from the source ranking function and the commit ranking function.

Step 415 includes presenting the source file responsive to the report. The source file may be presented by transmitting a response to a user device pursuant to a request from the user device to analyze the source files of a programming project with respect to a report of a bug. The response may be transmitted as part of a message that may include an identification of a source file that may be related to the bug from the report, and the response may include text extracted from the source file. The identification of the source file, the text from the source file, and the source file itself may be displayed on the user device.

In an embodiment, the process (400) includes applying a pooling layer after a last attention layer of the fine-tuned language model to a report embedding vector, a source embedding vector, and a commit embedding vector from the last attention layer to respectively generate the report vector, the source vector, and the commit vector. The report embedding vector may be one of multiple report embedding vectors that are generated from the tokens of report text from the text of a report. The source embedding vector may be one of a set of source embedding vectors generated from the tokens of a source file segment extracted from the text of a source code file. The commit embedding vector may be one of a set of commit embedding vectors extracted from the tokens of a commit message extracted from a commit.

The set of report embedding vectors, the set of source embedding vectors, and the set of commit embedding vectors may be processed individually by the pooling layer to form the report vector, the source vector, and the commit vector. For example, the report vector may be generated by the pooling layer from the set of report embedding vectors. Similarly, the source vector may be generated from the set of source embedding vectors and the commit vector may be generated from the set of commit embedding vectors. Different pooling methods may be used.

In an embodiment, the pooling method may output the mean of a set of vectors. For example, each vector of a set of vectors may have the same number of values within the vector. The first value from each vector may be averaged to identify a mean that becomes the first value of the output vector. The second value of each vector of the set of vectors inputs to the pooling layer may be averaged to generate the mean that is the value for the second value of the output vector, and so on for the remaining values in the vectors.

In an embodiment, the process (400) includes applying a file ranking model to a set of file source ranks and to a set of file commit ranks to identify a set of file ranks corresponding to the report and identifying the source file. The file ranking model receives a set of file source ranks and a set of file commit ranks. In an embodiment, the file ranking model uses a majority voting algorithm to generate file ranks for each of the files identified by the file source ranks and the file commit ranks. As an example, each time a file is referenced by one of the file source ranks or by one of the file commit ranks, the file rank for that file may be incremented by 1. The source code files in the project may be ranked by the number of votes each source code file receives from processing the file source ranks and the file commit ranks.

In an embodiment, the process (400) includes applying the fine-tuned language model to the source text. The source text may overlap with previous source text from the source file and may overlap with subsequent source text from the source file. The previous source text, the source text, and the subsequent source text may be segments of a source code file. The overlap between the segments may be measured by characters, words, tokens, embedded vectors, etc. For example, the overlap may be 12 tokens worth of text between adjacent segments. In an embodiment, the overlap may be double ended so that a segment includes text that overlaps with a previous segment and includes text that overlaps with a subsequent segment. In an embodiment, the overlap may be single ended so that the beginning or the ending of a segment respectively overlaps with a previous or subsequent segment.

Turning to FIG. 4B, the process (450) fine tunes a pre-trained model to generate a fine-tuned model. The process (450) may include multiple steps (e.g., steps 452 through 462) that may execute on the components described in the other figures, including those of FIG. 1.

Step 452 includes applying the pre-trained language model to training report text from a training report and to training source text from a training source file to respectively generate a training report vector and a training source vector from the pre-trained language model. To generate the training report vector, the training report text may be extracted from the training report, converted to tokens, and the tokens may be converted to embedding vectors, which may then be combined to form the training report vector. Similarly, to generate the training source vector, training source text may be extracted from a training source file, the source text may be converted to tokens, and the tokens may be converted to embedding vectors that may combined to form the training source vector.

Step 455 includes applying a first batch loss function to a training report source score generated from the similarity model applied to the training report vector and the training source vector to generate a first batch loss. The training report source score may be one of multiple training report source scores for a batch.

In one embodiment, a programming project may have multiple files (e.g., hundreds to thousands of files) and a batch of these source code files for the programming project may be analyzed by the system. As an example, the batch may include 50 samples, which would be 50 source files or segments from source code files for which training report source scores are generated and fed to the first batch loss function. In an embodiment, the first batch loss function may take scalars (e.g., the batch of training report source scores that are scalar values) as an input for each sample within a batch. In an embodiment, the first batch loss function may take the mean squared error of a batch of training report source scores compared to corresponding training labels to generate the first batch loss.

Step 458 includes applying a second batch loss function to a training combined vector generated from the training report vector and the training source vector to generate a second batch loss. In an embodiment, the training combined vector may be generated by concatenating the training report vector with the training source vector. In an embodiment, the second batch loss function may take vectors (e.g., the batch of training combined vectors) as an input for each sample within a batch. In an embodiment, the second batch loss function may use a supervised contrastive learning algorithm to generate the second batch loss from a set of training combined vectors for a batch of training combined vectors.

Step 460 includes applying a loss function to a combined loss generated from a loss combination function applied to the first batch loss and the second batch loss to generate training updates for the pre-trained language model. In an embodiment, the loss combination function may generate a weighted combination of the first batch loss and the second batch loss. In an embodiment, different algorithms may be used for the loss function. In an embodiment, an adaptive moment estimation algorithm with weight decay (ADAMW) optimization function may be used. In an embodiment, a gradient descent algorithm may be used to generate the training updates from the combined loss.

Step 462 includes applying the training updates to the pre-trained language model to fine tune the pre-trained language model and generate the fine-tuned language model. The training updates may include updates for the values of each of the parameters in the pre-trained language model. Training updates calculated from different samples or batches may be combined before being applied to the pre-trained language model. In an embodiment, the training updates may be saved separately from the pre-trained language model and distributed with the pre-trained language model.

In an embodiment, the process (450) includes applying a pooling layer after a last attention layer of a pre-trained language model to a set of training report embedding vectors and to a set of training source embedding vectors from the last attention layer to respectively generate a training report vector and a training source vector. In an embodiment, the pooling layer may combine a set of vectors into a single vector. In an embodiment, the pooling layer may calculate the mean of the set of vectors to generate the output vector.

In an embodiment, the process (450) includes applying a batch loss function comprising a mean squared error function to a batch of training report source scores. In an embodiment, the mean squared error function may take a set (e.g., a batch) of scalar values as input and output a single scalar value, which may be a first batch loss.

In an embodiment, the process (450) includes applying a batch loss function comprising a supervised contrastive learning function to a batch of training combined vectors generated from a batch of training report vectors combined with a batch of training source vectors. In an embodiment, the supervised contrastive learning function takes a set (e.g., a batch) of vectors for a batch as input to output a scalar value as the loss for the batch.

In an embodiment, the process (450) includes applying a combined loss function to a first batch loss and a second batch loss to generate a combined loss used to generate training updates for the pre-trained language model. In an embodiment, the combined loss function may be a weighted combination of a first batch loss generated from scalar input values and a second batch loss generated from vector input values.

In an embodiment, the process (450) includes selecting a set of training source files comprising a set of positive samples and a set of negative samples. The set of negative samples includes a negative sample that does not correspond to a training report and is selected based on similarity between a negative training source file of the negative sample and a positive training source file of a positive sample of the set of positive samples. Selecting negative samples that are similar to positive samples increases the quality and accuracy of the fine-tuned language model when trained on the negative samples.

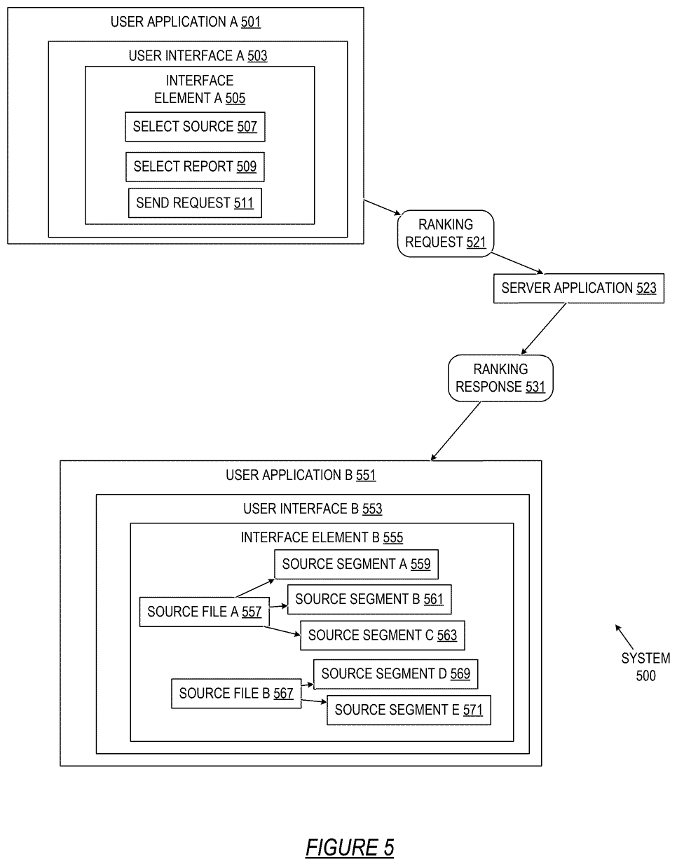

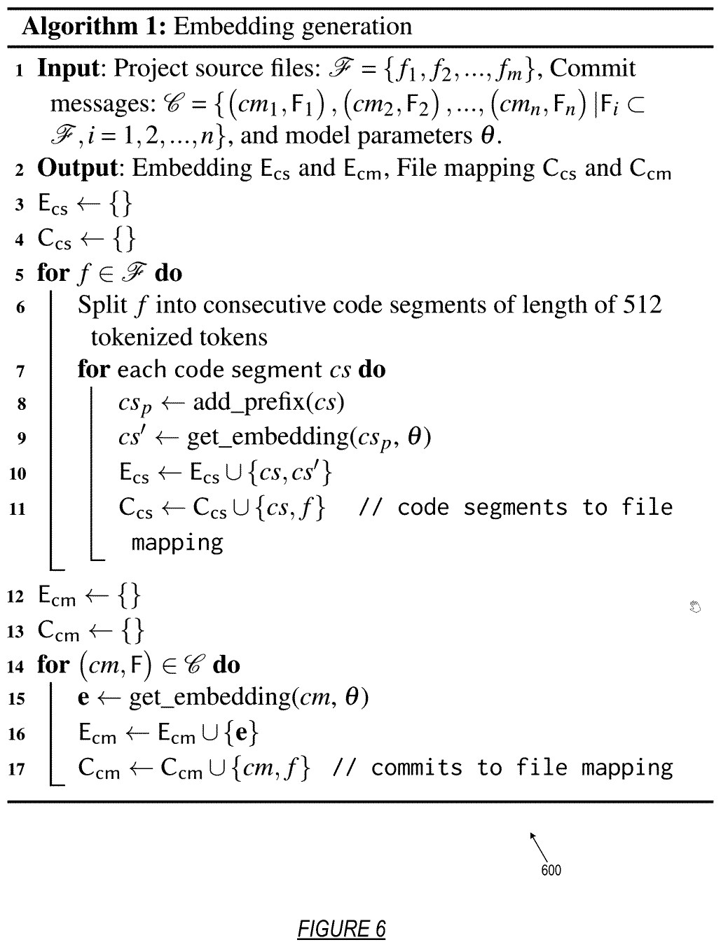

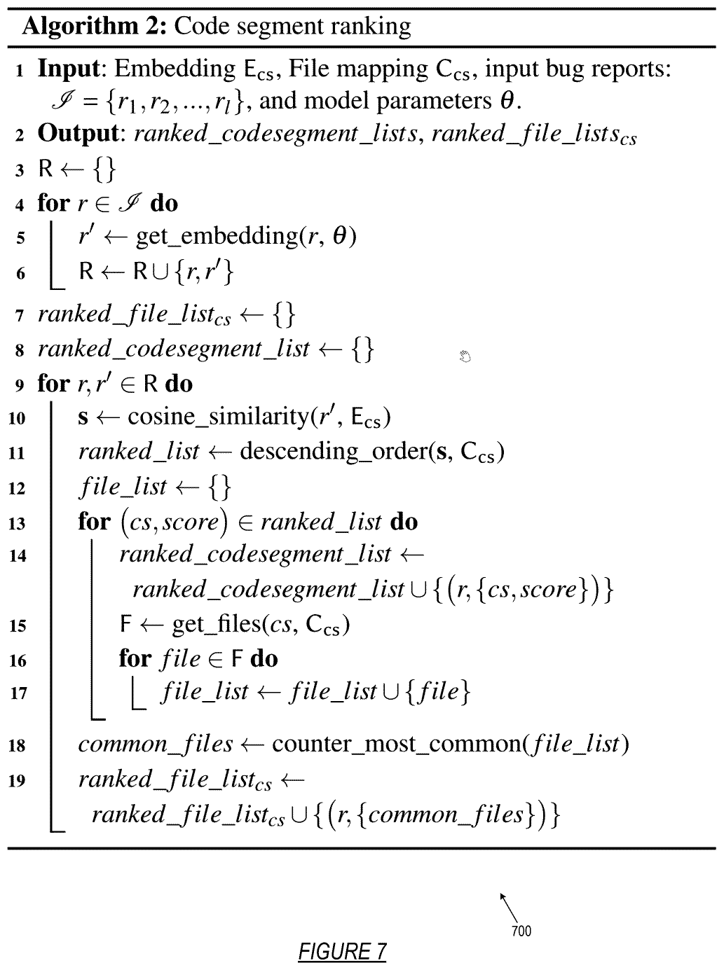

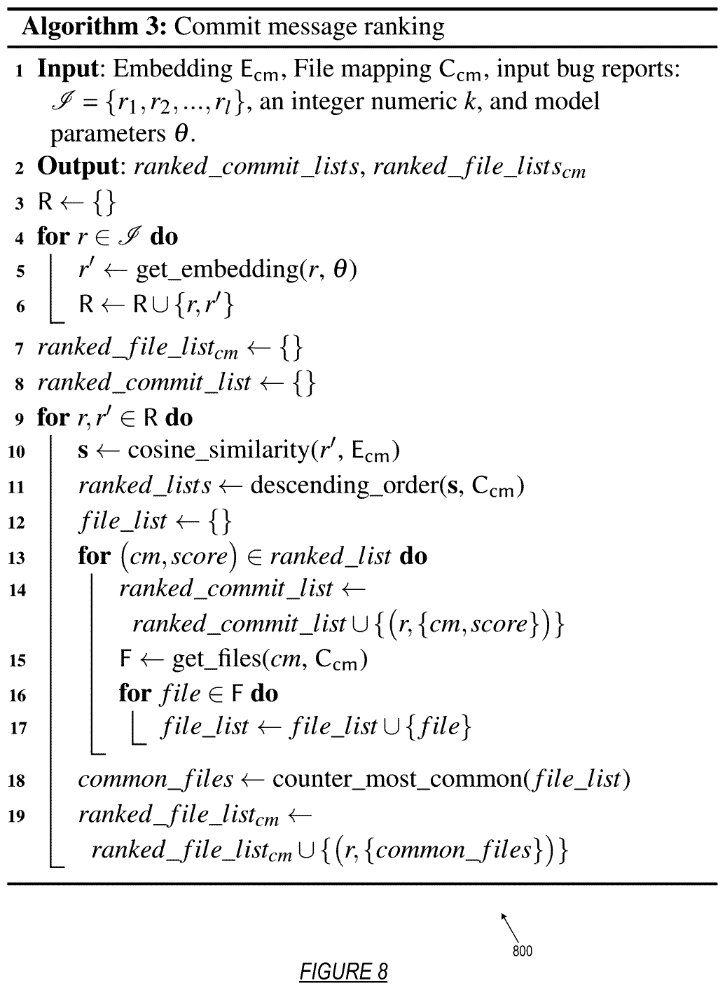

Turning to FIG. 5, the system (500) implements the use of a pre-trained large language model for bug localization. The user application A (501) may execute on a user device to display the user interface A (503). The user interface A (503) includes the interface element A (505), which includes the interface elements (507), (509), and (511). The interface element (507) is a button that may be selected to open a menu for the user to identify the source files to be analyzed by the system (500). The interface element (509) is another button that may be selected by the user to open a menu to select a report of a bug to be analyzed by the system (500). After selecting the source files and the report, the user application A (501) transmits the ranking request (521) to the server application (523) upon the selection of the interface element (button) (511).

The server application (523) receives the ranking request (521) and processes the ranking request (521) using a pre-trained language model that has been fine-tuned to generate the ranking response (531). The server application (523) analyzes the source files with respect to the report that was selected by the user. The ranking response (531) is transmitted from the server application (523) to the user application B (551).

The user application B (551) is an updated version of the user application A (501) after receiving the ranking response (531). The user application B (551) includes the user interface B (553) which is updated from the user interface A (503). The user interface B (553) includes the interface element B (555) which is updated from the interface element A (505). The interface element B (555) displays the interface elements (557) through (571). The interface element (557) identifies the source file A. The file ranks included in the ranking response (531) indicate that the source file A (displayed with the interface element (557)) and the source file B (displayed with the interface element (567)) are the two files that are most likely to be relevant to resolving the bug identified in the report selected by the user with the interface element (509).

The interface element B (555) displays the interface elements (559), (561), and (563) which respectively identify the source segments A, B, and C from the source file A (557). The interface element B (555) also displays the source segment D (with the interface element (569)) and the source segment E (with the interface element (571)) of the source file B (displayed with the interface element (567)). The source segments may be the segments of the source files that are relevant to the report selected by the user. For example, a user may open the source file A in an editor to view and edit one or more of the source segments A, B, and C, which may resolve the bug identified in the report.

Turning to FIG. 6, the table 600 displays lines of pseudo code for generating embeddings. Line 1 identifies the inputs as being project source files, commit messages (extracted from commits), and model parameters for a pre-trained language model. Line 2 indicates that the outputs include arrays for the embedding vectors of the code segments (extracted from source code files) (“E_{cs}”) and embedding vectors for the commit messages (“E_{cm}”). The output also includes mappings from code segments to files (“C_{cs}”) and from commit messages to files (“C_{cm}”). Lines 3 and 4 initialize some of the parameters. Lines 5 through 11 populate the code segment lists (“E_{cs}”) and (“C_{cs}”). The lines 12 and 13 initialize the lists for the embedding vectors of the commit messages and the mappings for the commit messages (“C_{cm}”). The lines 14 through 17 populate the lists for the embedding vectors of the commit messages (“E_{cm}”) and the mappings for the commit messages (“C_{cm}”).

Turning to FIG. 7, the table 700 shows lines of pseudo code for an algorithm to rank code segments. Line 1 indicates the inputs include embeddings for the code segments (“E_{cs}”), file mappings for the code segments (“C_{cs}”), bug reports, and model parameters for the fine-tuned language model. Line 2 indicates that the output includes a ranked list of code segments and a ranked list of files. Line 3 initializes the list of reports and lines 4 through 6 populate the list of reports (“R”) with pairs that include the report (“r”) and the embedding for the report (“r”). Lines 7 and 8 initialize the ranked file list and the ranked code segment list. Lines 9 through 19 iterate through the reports to generate the ranked file list and the ranked code segment list.

Turning to FIG. 8, the table 800 includes lines of pseudo code for an algorithm to rank commit messages. Line 1 indicates the inputs include embeddings for the commit messages (“E_{cm}”), file mappings for the commit messages (“C_{cm}”), bug reports, an integer numeric (“k”), and model parameters for a fine-tuned language model. The line 2 indicates the output is a ranked commit list and ranked file list. Line 3 initializes a list of reports and lines 4 through 6 populate the list of reports with pairs that include the report and the embedding for the report. Lines 7 and 8 initialize the ranked file list and the ranked commit list. Lines 9 through 19 process the reports with the commit messages to generate the ranked commit lists and the ranked file list.

Turning to FIG. 9, the table 900 shows lines of pseudo code for an algorithm for a ranking algorithm to rank files with majority voting. Line 1 indicates the inputs includes embeddings for code segments (“E_{cs}”) and commit messages (“E_{cm}”), mappings for code segments (“C_{cs}”) and commit messages (“C_{cm}”), reports of bugs, an integer numeric (“k”), and model parameters for a fine-tuned language model. Line 2 indicates the output is a ranked file list. Line 3 generates the ranked file list using the algorithm of FIG. 7. Line 4 generates a ranked file list for commit messages using the algorithm of FIG. 8. Lines 5 through 8 generate the ranked file list using the ranked file lists for the code segments and commit messages.

Turning to FIG. 10, the table 1000 includes lines of pseudo code for an algorithm to fine-tune a pre-trained language model. Line 1 indicates the inputs include positive training samples, source code files, validation samples, model parameters which may be for the pre-trained language model, an integer numeric step (“t”), the number of files to consider, and weights for combining losses from multiple loss functions. Line 2 indicates the output includes the parameters for the fine-tuned language model. Line 3 initializes the listing of training samples (“T”). Lines 4 through 7 populate the listing of training samples. In an embodiment, each sample includes a positive sample and a negative sample. Lines 8 and 9 initialize the step and best accuracy variables. Lines 10 through 21 trains the machine learning model in batches calculating mean squared error and supervised contrasted learning losses to generate updates to the machine learning model and form a fine-tuned language model.

Turning to FIG. 11, the table 1100 includes lines of pseudo code for an algorithm for a ranking algorithm for fine tuning. Line 1 indicates the inputs include the project source files, input reports, an integer (“k”), and model parameters, which may be for a fine-tuned language model. Line 2 indicates the output is the accuracy at (“k”). Line 3 initializes the list of embeddings and lines 4 through 6 populate the list of embeddings. Line 7 initializes the list of reports and lines 8 through 10 populate the list of reports. Line 11 initializes the accuracy at (“k”) and lines 12 through 24 calculates the accuracy at (“k”).

“Accuracy at k” is a metric to identify performance of the system. In an embodiment, the accuracy at k identifies the likelihood that a source file that corresponds to a report of a bug is in the top k files in a list of files. For example, k may be “10” and the accuracy at k may identify the percentage probability that the file corresponding to the bug report is within the first “10” files identified in a list of files.

Embodiments may be implemented on a special purpose computing system specifically designed to achieve the improved technological result. Turning to FIG. 12A and FIG. 12B, the special purpose computing system (1200) may include one or more computer processors (1202), non-persistent storage (1204), persistent storage (1206), a communication interface (1212) (e.g., Bluetooth interface, infrared interface, network interface, optical interface, etc.), and numerous other elements and functionalities that implement the features and elements of the disclosure. The computer processor(s) (1202) may be an integrated circuit for processing instructions. The computer processor(s) may be one or more cores or micro-cores of a processor. The computer processor(s) (1202) includes one or more processors. The one or more processors may include a central processing unit (CPU), a graphics processing unit (GPU), a tensor processing unit (TPU), combinations thereof, etc.

The input devices (1210) may include a touchscreen, keyboard, mouse, microphone, touchpad, electronic pen, or any other type of input device. The input devices (1210) may receive inputs from a user that are responsive to data and messages presented by the output devices (1208). The inputs may include text input, audio input, video input, etc., which may be processed and transmitted by the computing system (1200) in accordance with the disclosure. The communication interface (1212) may include an integrated circuit for connecting the computing system (1200) to a network (not shown) (e.g., a local area network (LAN), a wide area network (WAN) such as the Internet, mobile network, or any other type of network), and/or to another device, such as another computing device.

Further, the output devices (1208) may include a display device, a printer, external storage, or any other output device. One or more of the output devices may be the same or different from the input device(s). The input and output device(s) may be locally or remotely connected to the computer processor(s) (1202). Many different types of computing systems exist, and the aforementioned input and output device(s) may take other forms. The output devices (1208) may display data and messages that are transmitted and received by the computing system (1200). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (1200) in FIG. 12A may be connected to or be a part of a network. For example, as shown in FIG. 12B, the network (1220) may include multiple nodes (e.g., node X (1222), node Y (1224)). Each node may correspond to a computing system, such as the computing system shown in FIG. 12A, or a group of nodes combined may correspond to the computing system shown in FIG. 12A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1200) may be located at a remote location and connected to the other elements over a network.

The nodes (e.g., node X (1222), node Y (1224)) in the network (1220) may be configured to provide services for a client device (1226), including receiving requests and transmitting responses to the client device (1226). For example, the nodes may be part of a cloud computing system. The client device (1226) may be a computing system, such as the computing system shown in FIG. 12A. Further, the client device (1226) may include and/or perform all or a portion of one or more embodiments of the disclosure.

The computing system of FIG. 12A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
receiving a report;
applying a fine-tuned language model to report text from the report, to source text from a source file of a set of source files, and to commit text from a commit of a set of commits to respectively generate a report vector, a source vector, and a commit vector from the fine-tuned language model;
applying a similarity model to the report vector and the source vector to generate a report source score;
applying the similarity model to the report vector and the commit vector to generate a report commit score;
applying a ranking model to the report source score and the report commit score to identify the source file corresponding to the report; and
presenting the source file responsive to the report.

2. The method of claim 1, further comprising:
applying the fine-tuned language model, wherein the fine-tuned language model is generated from fine tuning a pre-trained language model by:
applying the pre-trained language model to training report text from a training report and to training source text from a training source file to respectively generate a training report vector and a training source vector from the pre-trained language model,
applying a first batch loss function to a training report source score generated from the similarity model applied to the training report vector and the training source vector to generate a first batch loss,
applying a second batch loss function to a training combined vector generated from the training report vector and the training source vector to generate a second batch loss,
applying a loss function to a combined loss generated from a loss combination function applied to the first batch loss and the second batch loss to generate a training update for the pre-trained language model, and
applying the training update to the pre-trained language model to fine tune the pre-trained language model and generate the fine-tuned language model.

3. The method of claim 1, further comprising:
applying a pooling layer after a last attention layer of a pre-trained language model to a set of training report embedding vectors and to a set of training source embedding vectors from the last attention layer to respectively generate a training report vector and a training source vector.

4. The method of claim 1, further comprising:
applying the fine-tuned language model, wherein the fine-tuned language model is generated from fine tuning a pre-trained language model by:
applying a batch loss function comprising a mean squared error function to a batch of training report source scores.

5. The method of claim 1, further comprising:
applying the fine-tuned language model, wherein the fine-tuned language model is generated from fine tuning a pre-trained language model by:
applying a batch loss function comprising a supervised contrastive learning function to a batch of training combined vectors, the batch of training combined vectors generated from a batch of training report vectors combined with a batch of training source vectors.

6. The method of claim 1, further comprising:
applying the fine-tuned language model, wherein the fine-tuned language model is generated by fine tuning a pre-trained language model by:
applying a combined loss function to a first batch loss and a second batch loss to generate a combined loss used to generate training updates for the pre-trained language model.

7. The method of claim 1, further comprising:
applying the fine-tuned language model, wherein the fine-tuned language model is generated from fine tuning a pre-trained language model by:
selecting a set of training source files comprising a set of positive samples and a set of negative samples,
wherein the set of negative samples comprises a negative sample that does not correspond to a training report and is selected based on similarity between a negative training source file of the negative sample and a positive training source file of a positive sample of the set of positive samples.

8. The method of claim 1, further comprising:
applying a pooling layer after a last attention layer of the fine-tuned language model to a report embedding vector, a source embedding vector, and a commit embedding vector from the last attention layer to respectively generate the report vector, the source vector, and the commit vector.

9. The method of claim 1, further comprising:
applying a file ranking model to a set of file source ranks and to a set of file commit ranks to identify a set of file ranks corresponding to the report and identifying the source file.

10. The method of claim 1, further comprising:
applying the fine-tuned language model to the source text, wherein the source text overlaps with one or more of a previous source text from the source file and a subsequent source text from the source file.

11. A system comprising
at least one processor; and
an application that, when executing on the at least one processor, performs:
receiving a report,
applying a fine-tuned language model to report text from the report, to source text from a source file of a set of source files, and to commit text from a commit of a set of commits to respectively generate a report vector, a source vector, and a commit vector from the fine-tuned language model,
applying a similarity model to the report vector and the source vector to generate a report source score,
applying the similarity model to the report vector and the commit vector to generate a report commit score,
applying a ranking model to the report source score and the report commit score to identify the source file corresponding to the report, and
presenting the source file responsive to the report.

12. The system of claim 11, wherein the application further performs:
applying the fine-tuned language model, wherein the fine-tuned language model is generated from fine tuning a pre-trained language model by:
applying the pre-trained language model to training report text from a training report and to training source text from a training source file to respectively generate a training report vector and a training source vector from the pre-trained language model,
applying a first batch loss function to a training report source score generated from the similarity model applied to the training report vector and the training source vector to generate a first batch loss,
applying a second batch loss function to a training combined vector generated from the training report vector and the training source vector to generate a second batch loss,
applying a combined loss function to a combined loss generated from a combination model applied to the first batch loss and the second batch loss to generate a training update for the pre-trained language model, and
applying the training update to the pre-trained language model to fine tune the pre-trained language model and generate the fine-tuned language model.

13. The system of claim 11, wherein the application further performs:
applying a pooling layer after a last attention layer of a pre-trained language model to a set of training report embedding vectors and to a set of training source embedding vectors from the last attention layer to respectively generate a training report vector and a training source vector.

14. The system of claim 11, wherein the application further performs:
applying the fine-tuned language model, wherein the fine-tuned language model is generated from fine tuning a pre-trained language model by:
applying a batch loss function comprising a mean squared error function to a batch of training report source scores.

15. The system of claim 11, wherein the application further performs:
applying the fine-tuned language model, wherein the fine-tuned language model is generated from fine tuning a pre-trained language model by:
applying a batch loss function comprising a supervised contrastive learning function to a batch of training combined vectors, the batch of training combined vectors generated from a batch of training report vectors combined with a batch of training source vectors.

16. The system of claim 11, wherein the application further performs:
applying the fine-tuned language model, wherein the fine-tuned language model is generated by fine tuning a pre-trained language model by:
applying a combined loss function to a first batch loss and a second batch loss to generate a combined loss used to generate training updates for the pre-trained language model.

17. The system of claim 11, wherein the application further performs:
applying the fine-tuned language model, wherein the fine-tuned language model is generated from fine tuning a pre-trained language model by:
selecting a set of training source files comprising a set of positive samples and a set of negative samples, wherein the set of negative samples comprises a negative sample that does not correspond to a training report and is selected based on similarity between a negative training source file of the negative sample and a positive training source file of a positive sample of the set of positive samples.

18. The system of claim 11, wherein the application further performs:
applying a pooling layer after a last attention layer of the fine-tuned language model to a report embedding vector, a source embedding vector, and a commit embedding vector from the last attention layer to respectively generate the report vector, the source vector, and the commit vector.

19. The system of claim 11, further comprising:
applying a file ranking model to a set of file source ranks and to a set of file commit ranks to identify a set of file ranks corresponding to the report and identifying the source file.

20. A non-transitory computer readable medium comprising instructions executable by at least one processor to perform:
receiving a report;
applying a fine-tuned language model to report text from the report, to source text from a source file of a set of source files, and to commit text from a commit of a set of commits to respectively generate a report vector, a source vector, and a commit vector from the fine-tuned language model;
applying a similarity model to the report vector and the source vector to generate a report source score;
applying the similarity model to the report vector and the commit vector to generate a report commit score;
applying a ranking model to the report source score and the report commit score to identify the source file corresponding to the report; and
presenting the source file responsive to the report.
